(19) United States
(12) Patent Application Publication
(10) Pub. No.: US 2011/0280648 A1
(43) Pub. Date: Nov. 17, 2011

(54) QUICK COUPLING DEVICE FOR WORK VEHICLES AND MACHINES IN GENERAL

(76) Inventors: Gianluca Malacrino, Monta (IT); Massimiliano Marovino, Monselica (IT)

(21) Appl. No.: 13/145,716

(22) PCT Filed: Jan. 23, 2010
(86) PCT No.: PCT/EP2010/000385

§ 371 Date: Jul. 21, 2011

(30) Foreign Application Priority Data
Jan. 23, 2009 (IT) GE2009A000003

(51) Int. Cl. F16B 1/00

(52) U.S. Cl. 403/31

(57) ABSTRACT

A quick coupling device for work vehicles has two locking pins operated by a link system that is actuated by an actuation means so as to define at least two positions of said locking pins: a released position, in which said pins are retracted, and a locking position, in which said pins are extended and interfere with the equipment or tool to be locked.

The present invention relates to a quick coupling device for work vehicles and machines in general.

The device according to the present invention can be used for all work vehicles in earth-moving, in agriculture, in lifting, where it is required to change the tool very often.

Conventional quick couplings are constituted by a separate structure that connects the tool to the machine.

U.S. Pat. No. 3,272,264 discloses a latching mechanism, for removably securing various tools to a bulldozer, constituted by a framework to be secured to the bulldozer. The latching mechanism of U.S. Pat. No. 3,272,264 is rather bulky and is adapted to large tools, such as the blade or skip loader bucket, typically employed in a bulldozer.

EP-1258567 discloses a quick coupler having cap-shaped coupler pins inserted in the hydraulic cylinder which constitutes the actuator. The coupler pins also operate as the pistons of the hydraulic system. Such construction makes the coupler pins weaker.

WO2007/038960 discloses a safety system for locking the tool to the machine within a traditional quick coupling device constituted by a separate structure that is interposed between the machine and the tool. Such quick coupling substantially modifies the original geometry of the machine and its tool.

The aim of the present invention is to provide a quick coupling device that is an integral part of the machine without adding a connection body between the machine and the tool.

Within such aim, an object of the present invention is to provide a constructively simple and reliable device.

This aim and these and other objects which will become better apparent hereinafter are achieved by a quick coupling device for work vehicles and machines in general, characterized in that it comprises one or more locking pins operated by a link system that is actuated by an actuation means so as to define at least two positions of said locking pins: a released position, in which said pins are retracted, and a locking position, in which said pins are extended and interfere with a piece of equipment to be engaged with said work vehicle or machine.

Further characteristics and advantages will become better apparent from the description of preferred but not exclusive embodiments of the invention, illustrated by way of non-limiting example in the accompanying drawings, wherein:

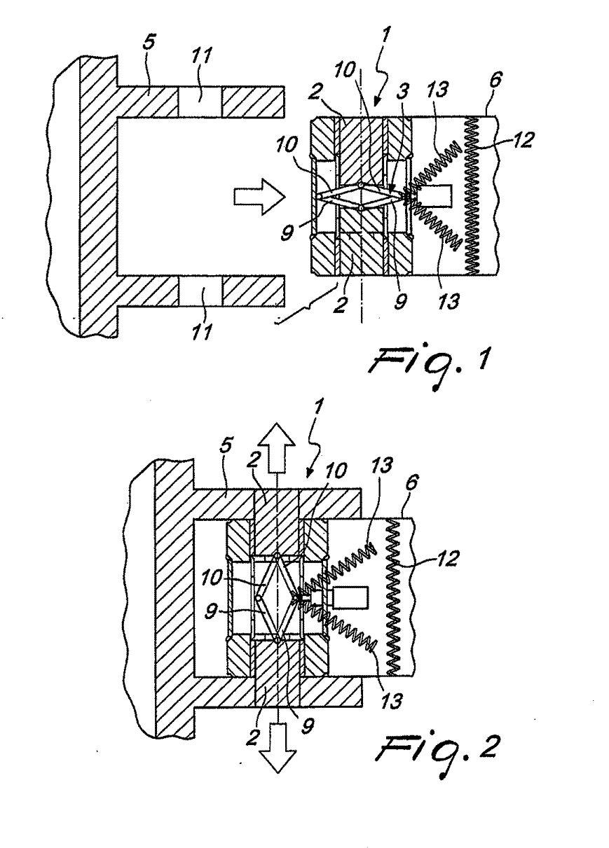

FIG. 1 is a partially sectional schematic view of a quick coupling device according to the invention, shown in the released condition;

FIG. 2 is a view, similar to the preceding one, but illustrating the device in the locking position;

FIG. 3 is a partially sectional schematic view of a further embodiment of the quick coupling device, shown in the released condition;

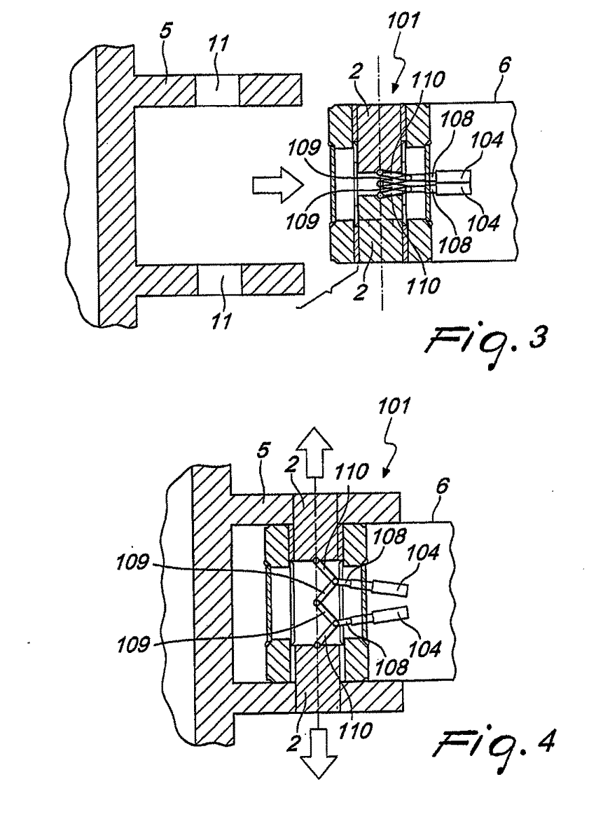

FIG. 4 is a view, similar to the preceding one, but illustrating the device in the locking position;

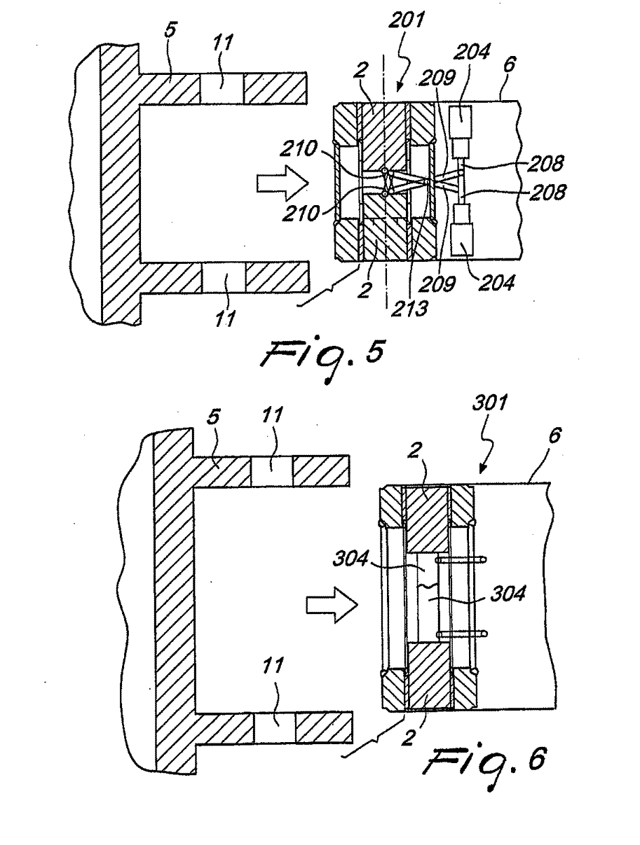

FIG. 5 is a partially sectional schematic view of a further embodiment of the quick coupling device shown in the released condition;

FIG. 6 is a partially sectional schematic view of a further embodiment of the quick coupling device shown in the release position;

FIG. 7 is a view similar to the preceding one but showing the device in the locking position;

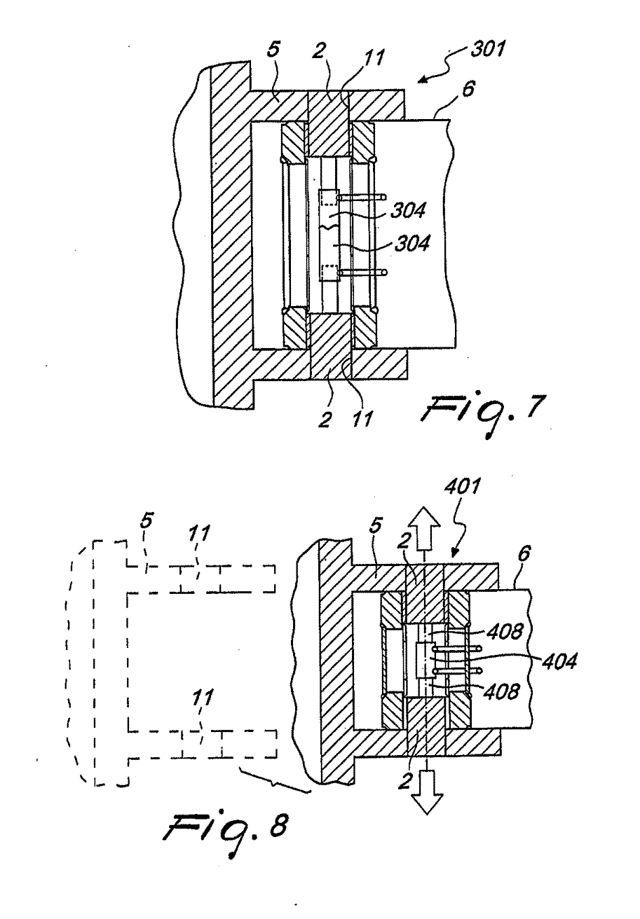

FIG. 8 is a partially sectional schematic view of a further embodiment of the quick coupling device, shown in the locking position;

FIG. 9 is a partially sectional schematic view of a further embodiment of the quick coupling device, shown in the locking position;

FIG. 10 is perspective view showing an example of application of the device to a work vehicle;

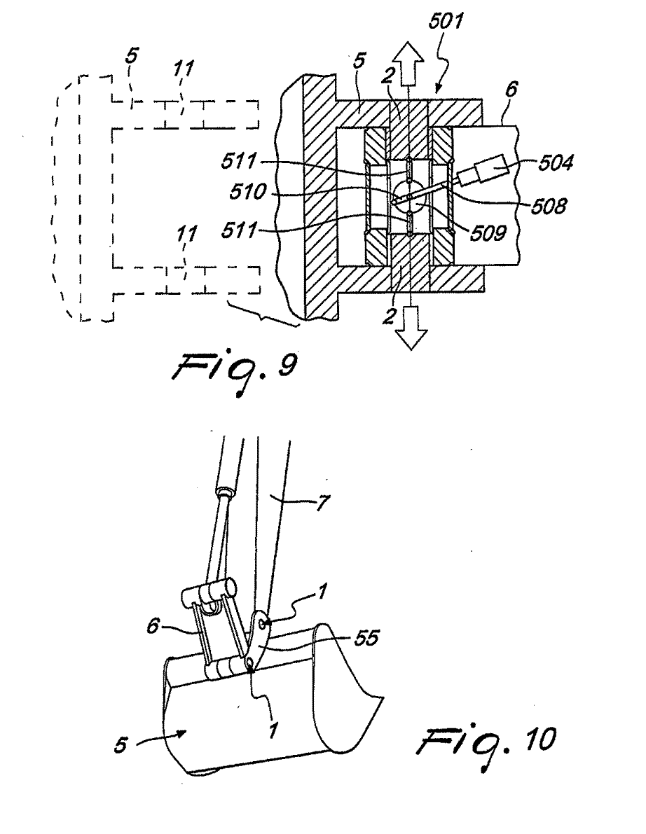

FIG. 11 is a perspective view of a portion of a machine having a quick coupling device according to the present invention;

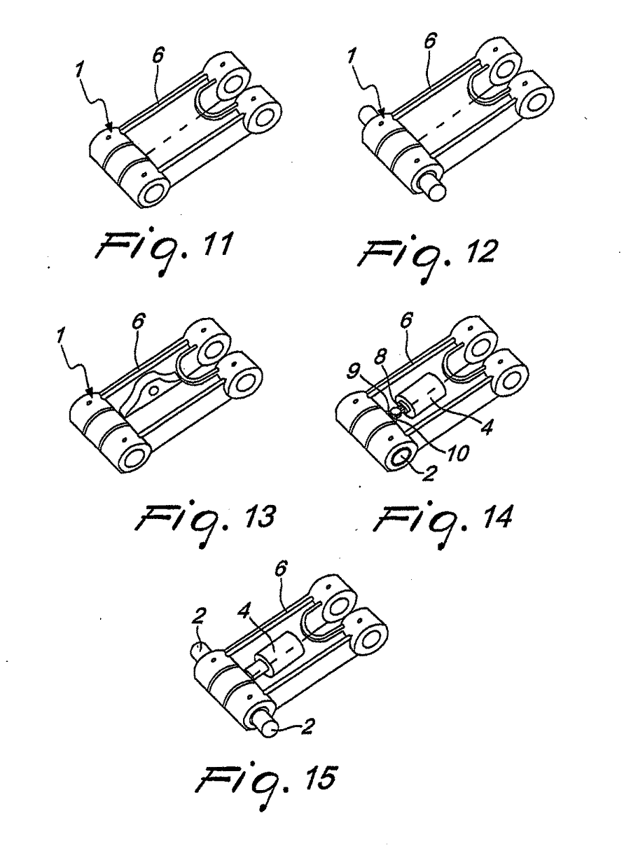

FIG. 12 is a view similar to the preceding one showing the device in the condition in which the pins are extended;

FIG. 13 is a perspective view of the device of FIG. 11, viewed from the opposite side;

FIG. 14 is perspective view of a portion of a machine having a quick coupling device according to a further aspect of the invention, wherein the actuation piston of the device is visible;

FIG. 15 is a view similar to the preceding one but with the pins in the extended position;

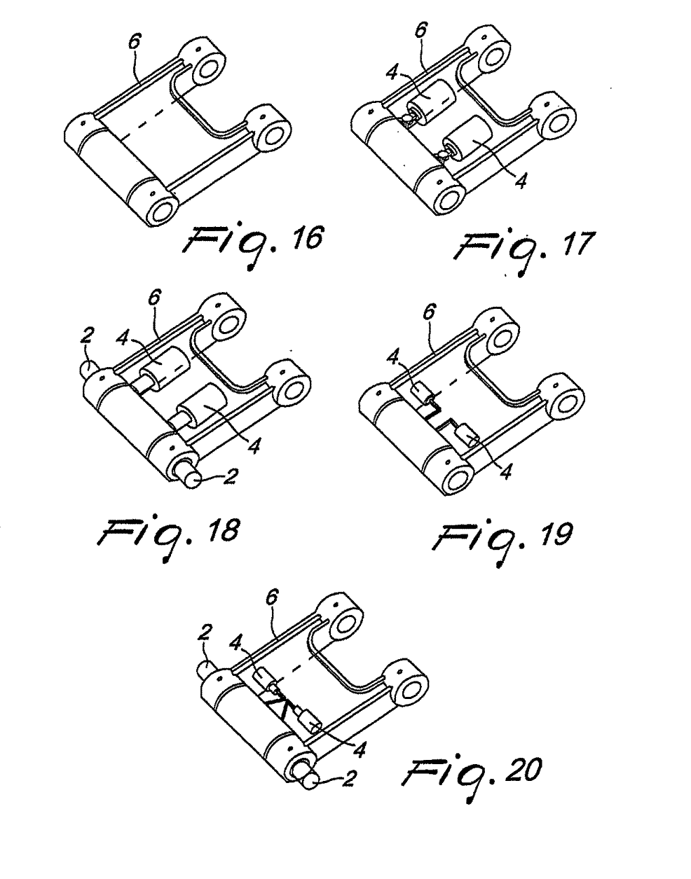

FIG. 16 is a perspective view of another component part of a machine having the device according to the present invention;

FIG. 17 is a perspective view of the component part of the preceding figure, provided with a device according to a further embodiment of the invention, constituted by two actuation pistons;

FIG. 18 is a perspective view of the component part of the preceding figure, provided with a device according to still a further embodiment of the invention, constituted by two actuation pistons;

FIG. 19 is a perspective view of the component part of the preceding figure, provided with a device according to still a further embodiment of the invention, constituted by two actuation pistons arranged parallel to the locking pins;

FIG. 20 is a perspective view of the component part of the preceding figure, provided with a device according to still a further embodiment of the invention, constituted by two actuation pistons;

FIG. 21 is a partially sectional front view of a further embodiment of the quick coupling device, shown in the release position;

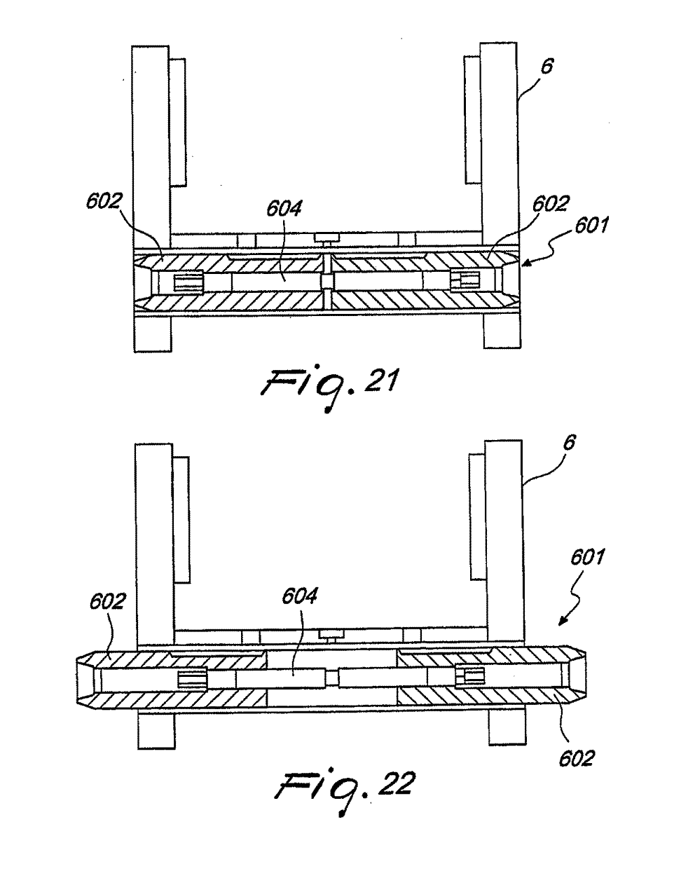

FIG. 22 is a view, similar to the preceding one but illustrating the device in the locking position;

FIG. 23 is a partially sectional front view of a further embodiment of the quick coupling device, shown in the release position;

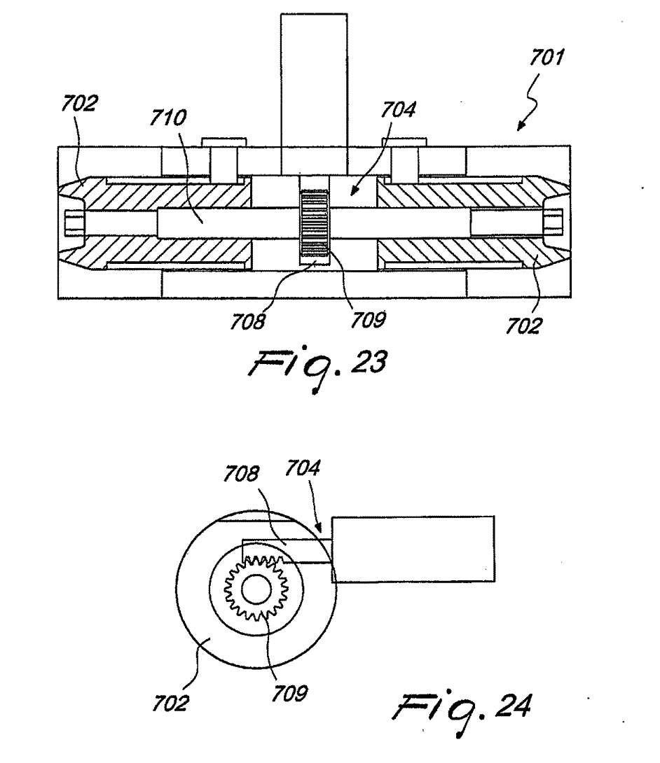

FIG. 24 is a partial side view of the actuation means of the device of the preceding figure;

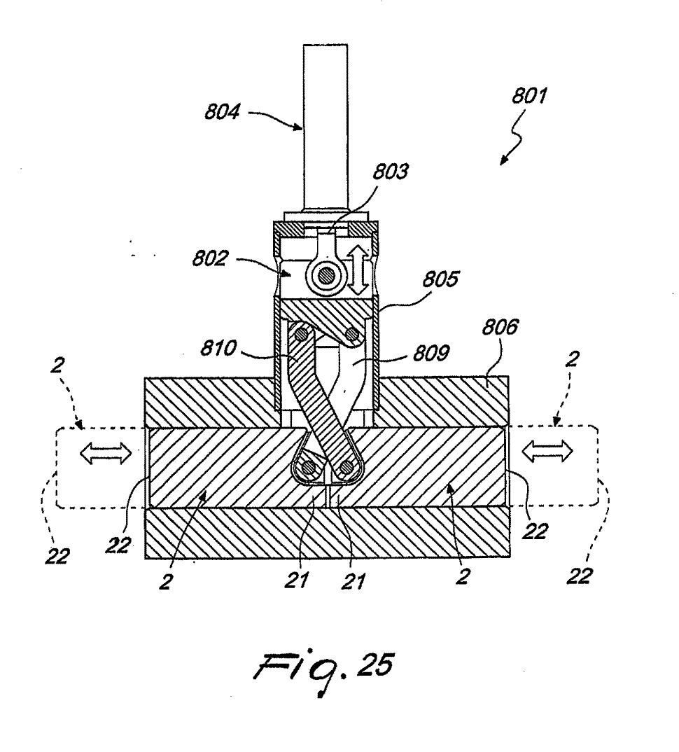

FIG. 25 is a partially sectional front view of the device according to the invention, shown in the release position.

With reference to the cited figures, the device according to the invention, generally designated by the reference numeral 1, comprises one or more locking pins 2, which are operated by a link system 3 which is actuated by an actuation means 4 so as to define at least two positions of the locking pins: a released position, shown in FIG. 1, in which the pins 2 are retracted, and a locking position, shown in FIG. 2, in which the pins are extended and interfere with the tool or equipment to be locked, designated by the reference numeral 5.

The device 1 is inserted in a body 6, which is part of the machine or work vehicle, for example the arm 7 of a work vehicle such as an excavator.

According to a first embodiment of the invention, which is shown in FIGS. 1 and 2, the quick coupling device comprises a hydraulic piston 4 which actuates two or four lever arms 9 and 10, by means of a stem 8. FIGS. 1 and 2 show two arms of an equipment provided with four arms.

Each lever arms 9 and 10 is pivoted to a respective pin 2, which slides within a transverse cavity and, by exiting the cavity, enters a respective engagement seat 11 formed in the structure 5.

Auxiliary springs 13, mounted obliquely, contribute to the movement of the lever system.

The auxiliary springs 13 facilitate the movement of the arms 9 and 10 especially in the release step, when the stem of the piston retracts in order to cause the retraction of the pins 2 into the released position, visible in FIG. 1.

Similar auxiliary springs can also be used in the various embodiments of the device, some of which will be described hereinafter.

The device can be provided with a safety system which is suitable to prevent accidental disengagement of the pins from the engagement seats.

The safety device is schematically illustrated in FIGS. 1 and 2 and comprises a spring 12 and a rigid member which is connected to the respective pin 2.

The spring 12 works by extension and therefore when it is compressed, as visible in FIG. 1, the quick coupling is released and ready to enter the tool.

During the movement of the piston 4, the spring 12 extends, thus assuming its natural shape, visible in FIG. 2, and by extending helps the effect of the piston 4 and its force on the pins for the mating and locking action of the quick coupling.

When the spring is completely extended, the pin 2 cannot move backwards and slide out of its seat, freeing the equipment, because the spring continues to push in the locking direction.

The spring 12 has a modulus that is sufficiently smaller than the force applied by the piston 4, so as to be able to compress it and thus cause the retraction of the pins within their seat in order to disengage the equipment.

Therefore, the springs are to be understood as a safety against accidental disengagement or release, in case of failure of the pistons, failure of the hydraulic circuit, etcetera.

The system is automatic and therefore very practical in the field, and the operator must not leave his seat in order to secure the quick coupling, a considerable advantage with respect to conventional systems.

FIGS. 3 and 4 illustrate a further embodiment of the quick coupling device according to the present invention, designated by the reference numeral 101, and comprising two hydraulic pistons 104 which actuate two respective lever arms 109 and 110, by means of a respective stem 108.

Each lever arm 110 is hinged to a respective pin 2, which slides within a transverse cavity and, by exiting the cavity, enters a respective engagement seat 11 provided in the equipment 5.

The lever arms 109 are mutually pivoted to each other.

FIG. 5 illustrates a further embodiment of the quick coupling device according to the present invention designated by the reference numeral 201 and comprising two hydraulic pistons 204, which are characterized in that they are arranged parallel to the sliding direction of the pins 2.

The two pistons 204 actuate a respective lever arm 209, by means of a respective stem 208. The lever arms 209 are mutually pivoted in the pivoting point 213.

The arms 209 have free ends pivoted to respective second lever arms 110, which in turn are pivoted to the respective pins 2.

The pins 2 slide within respective transverse cavities and, by exiting the cavities, enter respective engagement seats 11 provided in the equipment 5.

FIGS. 6 and 7 illustrate a further embodiment of the quick coupling device according to the present invention, designated by the reference numeral 301, which comprises two hydraulic pistons 304 which are arranged so as to be parallel to each other and to the sliding direction of the pins 2.

The two pistons 304 directly operate the respective pins 2, which slide within respective transverse cavities and, by exiting the cavities, enter respective engagement seats 11 provided in the equipment 5.

FIG. 8 illustrates a further embodiment of the quick coupling device according to the present invention, designated by the reference numeral 401, which comprises a single double-acting hydraulic piston 404, which has two mutually opposite actuation stems 408 which act directly on the respective locking pins 2.

FIG. 9 illustrates a further embodiment of the quick coupling device according to the present invention, designated by the reference numeral 501, which comprises an actuation lever 504 instead of a piston. The actuation lever 504 has an actuation stem 508 having a free end pivoted to a member 509 which rotates with respect to a center 510.

The ends of two lever arms 511 are pivoted on the rotating member 509 in a radially opposite position on the rotating member 509, and the free ends of the arms are pivoted to the respective pins 2.

The operation of the actuation lever 504 causes the rotation of the rotating member 509 and therefore a sliding motion of the pins 2 in order to lock and release the body 5.

FIGS. 21 and 22 are views of a further embodiment of the quick coupling device according to the present invention, designated by the reference numeral 601, which comprises a worm screw 600. The worm screw 600 is arranged coaxially to the pins 602. The worm screw 600 has ends associated with the pins.

The rotation of the worm screw 604 causes an axial movement of the pins 602, which slide within respective transverse cavities and, by exiting the cavities, enter respective engagement seats provided in the equipment.

The worm screw 604 can be operated both manually and by a mechanical actuation system, which may be internal or external to the machine.

FIGS. 23 and 24 are views of a further embodiment of the quick coupling device according to the present invention, designated by the reference numeral 701, which comprises a rack system 704 which is constituted by a rack 708 which actuates a pinion 709. Pinion 709 is associated with a shaft 710 which is coaxial to the pins 702. The ends of the shaft 710 are associated with the pins.

The rotation of the shaft 710 causes the axial movement of the pins 702, which slide within respective transverse cavities and, by exiting the cavities, enter respective engagement seats provided in the equipment.

The rack 708 can be actuated both manually and by a mechanical actuation system, which may be internal or external to the machine.

FIG. 10 shows an example of application of the device to a work vehicle, constituted by a bucket associated with an arm of the vehicle.

By way of example, a part of the quick coupling device 1 is located within the work vehicle, i.e., inside its arm 7, and applies its action to one end of a bucket portion 55, while another part of the device 1 is within the body 6 and applies its action to the other end of bucket portion 55.

FIGS. 11-15 illustrate an application of the device to a link member of the machine. The same device can be applied within the arm of the machine or within a component part of the machine, such as a link, according to the requirements.

FIGS. 16-20 are views of various embodiments of the invention.

FIG. 25 shows a further embodiment of the quick coupling device according to the present invention, designated by the reference numeral 801.

Device 801 comprises pins 2 slidingly arranged within a cavity formed in a body 806.

Pins 2 are substantially solid and smooth. Each pin 2 has an inner end 21 and an outer end 22. The inner ends 21 face each other while the outer ends 22 protrude from the body 806 when the device is in its locking position, as shown in dashed lines in FIG. 25.

A double action hydraulic cylinder 804 is mounted on a support cylinder 805 which is associated with body 806.

The hydraulic cylinder 804 has a piston 803 which is associated with a slider 802. Slider 802 is adapted to slide within the support cylinder 805 under the action of piston 803.

Two links 809 and 810 are articulated to the slider 802 and to the inner ends 21 of pins 2. Therefore, the motion of piston 803 causes the pins 2 to slide within the cavity and, by exiting the cavity, enter respective engagement seats 11 provided in the equipment 5.

The quick coupling device according to the present invention may be used in conventional machines of any type, such the excavator illustrated in FIG. 10.

The quick coupling device according to the invention may be provided as a kit, fitting existing machines or new machines.

The quick coupling device according to the present invention can be also used in agricultural machines, such as for example a combine harvester, when it is necessary to change the equipment for harvesting, for telescopic lifters, in order to change the application arranged on the tip of the arm, such as forks, mixer, etcetera, in a few seconds, with safety and convenience on the part of the operator.

The device is fitted inside the machine, where the arm is engaged and draws force for rotation, in the combine harvester, whereas in the telescopic lifter it is in the tip of the arm, where the last telescopic terminal is present, and in this case there is no need for a framework or supporting structure or raft of any kind, and the coupling lies within the arm.

The quick coupling kit for earth-movers, such as excavators, backhoes, mini-excavators, on tires or tracks, with front or back loader, is provided as in the examples described herein.

All the embodiments of the quick coupling device according to the present invention can be provided with a safety system capable of ensuring in a completely reliable manner the locking of the quick coupling even if the piston supply system breaks down, preventing their opening, and thus preventing the equipment from detaching if the pins disengage.

As an alternative to the spring system, another safety system may be constituted by mating slots for the pins as a safety against accidental disengagement in case of failure of the pistons, failure of the hydraulic circuit, etcetera.

The system is able to ensure locking of the quick coupling, i.e., its grip on the equipment even in case of oil leakage from the structure of the piston, failure of the stem, of the lever systems, thus being an absolute guarantee for work safety from any standpoint.

In practice it has been found that the device according to the invention achieves the intended aim and objects.

A feature of this device, with respect to conventional quick couplings, is constituted by the fact that the device is internal to the arm of the work vehicle and has an external component for the second pin.

The quick coupling device according to the present invention solves the problem of the large size of traditional quick couplings, which increase the radius at the tooth during the rotation of the fitted equipment.

The advantages of the device according to the present invention are several.

First of all, the machine that uses the device according to the invention has the equipment at the same point designed by the manufacturer, where the pins are currently present, differently from traditional quick couplings, which necessarily extend the arm due to their thickness, thus reducing up to 15-20% the penetration force, the jerk force, the ability to rotate of the equipment that uses a traditional quick coupling.

Further advantages are constituted by the safety of the coupling, which follows the initial characteristics of the manufacturer, i.e., engagement by means of pins, without thus providing a second structure that has to act as a joining member between the machine and the equipment.

The hydraulic or supply system for moving the pistons of the device according to the invention can be both the one currently commonly used for the “clamp-hammer” system or one that is designed ad hoc.

The device can be used for any size of work vehicle, from large ones to small ones.

It is stressed that this quick coupling device can be used for earth-movers for replacing the equipment on the arm, for telescopic lifters for replacing the equipment at the top of the telescopic arm, and for applying it, for combine harvesters to replace the various applications for threshing the various cultivations, all the previously illustrated examples being an integral part of the conceptual innovation of the present patent application.

The quick coupling kit can be for each individual machine in a number of units which can vary depending on the operating requirements and the technical needs for replacement of the equipment.

The pins of the device of the present invention are shorter than the pins used in traditional couplings for similar machines.

The quick coupling device according to the present invention does not modify the geometry of the machine and its tools.

The quick coupling device can be actuated from the driver's cab of the work vehicle.

This application claims the priority of Italian Patent Application No. GE2009A000003, filed on Jan. 23, 2009, the subject matter of which is incorporated herein by reference.

1. A quick coupling device for work vehicles and machines in general, characterized in that it comprises one or more locking pins operated by a link system that is actuated by an actuation means so as to define at least two positions of said locking pins: a released position, in which said pins are retracted, and a locking position, in which said pins are extended and interfere with a piece of equipment to be engaged with said work vehicle or machine.

2. The device according to claim 1, characterized in that it comprises two pins slidingly arranged within a cavity formed in a body; each pin has an inner end and an outer end; said inner ends face each other while said outer ends protrude from said body when said device is in said locking position; a double action hydraulic cylinder is mounted on a support cylinder which is associated with said body; said hydraulic cylinder has a piston which is associated with a slider; said slider is adapted to slide within said support cylinder under the action of said piston; two links are articulated to said slider and to said inner ends of said pins; a motion of said piston causes said pins to slide within said cavity and, by exiting said cavity, enter respective engagement seats provided in said equipment.

3. The device according to claim 2, characterized in that said pins are substantially solid and smooth.

4. The device according to claim, characterized in that it comprises a hydraulic piston which actuates, by means of a stem, two lever arms, each of which is pivoted to a respective pin, which slides within a transverse cavity and, by exiting the cavity, enters a respective engagement seat provided in said equipment.

5. The device according to one or more of the preceding claims, characterized in that it comprises a safety system which is suitable to prevent accidental disengagement of said pins from said engagement seats.

6. The device according to one or more of the preceding claims, characterized in that said safety device comprises a spring and a rigid member which is connected to the respective pin; said spring works by extension and when it is compressed the quick coupling is released and ready to enter the equipment; during the movement of said piston, said spring is extended and assists the effect of said piston and its force on the pins for the action for mating and locking the quick coupling; when said spring is extended completely, the pin can no longer retract and slide out of its seat, freeing the equipment, because said spring continues to push in the locking direction.

7. The device according to one or more of the preceding claims, characterized in that it comprises two hydraulic pistons which actuate, by means of a respective stem, two respective lever arms; each lever arm is pivoted to a respective pin, which slides within a transverse cavity and, by exiting the cavity, enters a respective engagement seat that is formed in the equipment; said lever arms are mutually pivoted.

8. The device according to one or more of the preceding claims, characterized in that it comprises two hydraulic pistons which are arranged parallel to the sliding direction of said pins; said pistons actuate, by means of a respective stem, a respective lever arm, said lever arms are mutually pivoted at a pivoting point; said arms are pivoted, at their free ends, to respective second lever arms, which in turn are pivoted to the respective pins; said pins slide within respective transverse cavities and, by exiting the cavities, enter respective engagement seats provided in the equipment.

9. The device according to one or more of the preceding claims, characterized in that it comprises two hydraulic pistons which are arranged parallel to each other and to the sliding direction of the pins; the two pistons operate directly the respective pins, which slide within respective transverse cavities and, by exiting the cavities, enter respective engagement seats provided in the equipment.

10. The device according to one or more of the preceding claims, characterized in that it comprises a single hydraulic piston which has two mutually opposite actuation stems which act directly on the respective locking pins.

11. The device according to one or more of the preceding claims, characterized in that it comprises an actuation lever which has an actuation stem whose free end is pivoted to a member which rotates with respect to a center; the ends of two lever arms are pivoted in a radially opposite position on said rotating member, and the free ends of said arms are pivoted to the respective pins; the actuation of said actuation lever causes the rotation of said rotating member and therefore the sliding movement of the pins in order to lock and release the body.

12. The device according to one or more of the preceding claims, characterized in that it comprises auxiliary springs which are mounted obliquely and contribute to the movement of the lever system; the auxiliary springs facilitate the movement of the arms during release, when the stem of piston retracts to cause the retraction of the pins in the released position.

13. The device according to one or more of the preceding claims, characterized in that it comprises a worm screw which is arranged coaxially to the pins and whose ends are associated with said pins; the rotation of the worm screw causes the axial movement of the pins, which slide within respective transverse cavities and, by exiting the cavities, enter respective engagement seats formed in the equipment; the worm screw can be actuated both manually and by means of a mechanical actuation system which is internal or external to the machine.

14. The device according to one or more of the preceding claims, characterized in that it comprises a rack system, which is constituted by a rack which actuates a sprocket which is jointly connected to a shaft which is coaxial to the pins and whose ends are associated with said pins; the rotation of the shaft causes the axial movement of the pins, which slide within respective transverse cavities and, by exiting the cavities, enter respective engagement seats provided in the equipment; the rack can be actuated both manually and by virtue of a mechanical actuation system which is internal or external to the machine.
